(19) United States
(12) Patent Application Publication
(10) Pub. No.: US 2002/0010801 A1
(43) Pub. Date: Jan. 24, 2002

(54) Server to third party serial gateway in a power control management system

(76) Inventors: Patrick S. Meagher, Norwalk, CT (US); Steven J. Brennan, Farmington, CT (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,517

(22) Filed: Apr. 20, 2001

Related U.S. Application Data
(60) Provisional application No. 60/199,678, filed on Apr. 21, 2000.

(51) Int. Cl. G06F 15/16

(52) U.S. Cl. 709/251; 709/203

(57) ABSTRACT

A power control management system includes an Ethernet server and at least one Ethernet gateway to facilitate communications with at least one intelligent end device (IEDs). A control computer includes the Ethernet server which is configured to create and encapsulate messages intended for the IEDs in an industry standard format. An Ethernet gateway is also included which is configured to communicate with the server, and further configured to transmit messages received from the server to the IEDs.

### CROSS REFERENCE TO RELATED APPLICATIONS

This application claims the benefit of U.S. Provisional Application No. 60/1 99,678 filed Apr. 21, 2000, which is hereby incorporated by reference in its entirety.

### BACKGROUND OF INVENTION

This invention relates generally to computer systems and in particular, to a power control management system in which a plurality of power monitoring and control devices are coupled to and controlled by a computer through a common bus.

In known power control management systems, a control computer connected to an Ethernet or other network uses a network gateway to communicate with intelligent end devices (IEDs), such as relays, meters, and other analysis tools and power control devices. The network gateway facilitates communications between the computer and the network. IEDs usually are not Ethernet compatible devices, and typically use a known serial communications protocol. In order for the network control computer to communicate with one or multiple IEDs in a power control management system a gateway is required. A gateway is typically a programmable hardware device programmed to convert Ethernet or another communication protocol to a communication protocol recognized by the IEDs. In known systems, the gateways and servers were custom designed for use with only certain devices or IEDs. In such known power control management systems, a packet of programming information to be received or transmitted by the IED was encapsulated by a header, the information in the header being in the protocol of the computer network. At the gateway the header information is stripped away leaving a packet of information to be interpreted by the IEDs. Typically, parts of the header information and the gateway are proprietary products delivered as part of an entire system, and the gateway is not able to communicate with or support other devices even though those devices had the same hardware interfaces and communications protocols as the IEDs.

### SUMMARY OF INVENTION

In one aspect, a power control management system is provided which includes an Ethernet server in a control computer and Ethernet gateways, which facilitate communications with intelligent end devices (IEDs). The server is configured to create and encapsulate messages intended for IEDs, in an industry standard format, and the Ethernet gateway is configured to communicate with the server.

In another aspect, a method is provided for communicating with intelligent end devices (IEDs) in a power control management system which includes at least one IED, an Ethernet gateway, and a control computer including an Ethernet server. The method includes electrically connecting the Ethernet gateway to the Ethernet server, configuring the server to create and encapsulate messages intended for IEDs in an industry standard format, configuring the gateway to remove the encapsulation from received messages for transmission to the IEDs, and transmitting the messages to the IEDs.

In yet another aspect, a computer is provided which is programmed to create and encapsulate messages in an industry standard format and further programmed to function as an Ethernet server for transmission of the messages.

In still another aspect, a gateway is provided which includes a programmable hardware device, configured to receive Ethernet messages from an Ethernet server in an industry standard format, remove both an Ethernet header and footer from the received Ethernet messages, leave messages intended for an intelligent end device and transmit messages to at least one intelligent end device.

### BRIEF DESCRIPTION OF DRAWINGS

FIG. 1 is a diagram of a known power control management system.

FIG. 2 is a diagram of a power control management system according to one embodiment of the present invention.

FIG. 3 is a TCP/IP Ethernet data packet in accordance with the invention.

### DETAILED DESCRIPTION

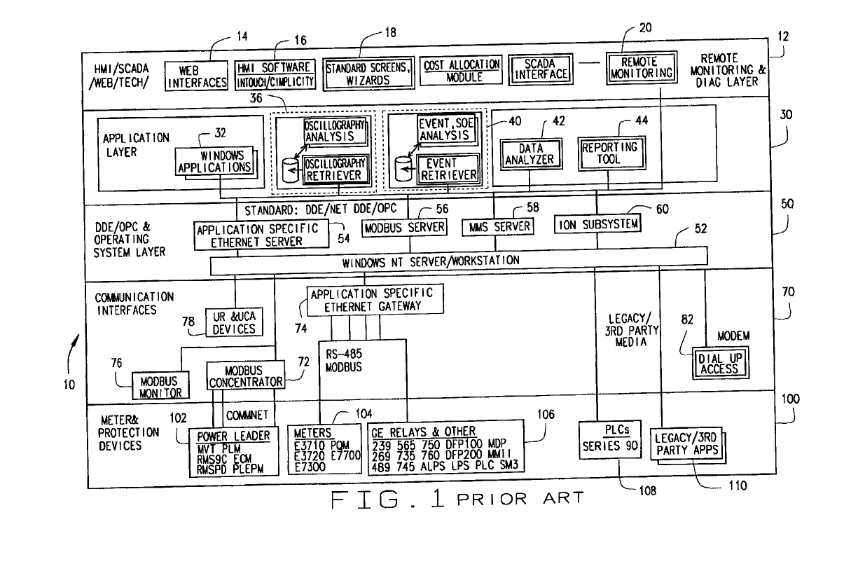

FIG. 1 is a diagram of a known power control management system 10. System 10 is divided into functional layers. A human interface layer 12 includes operating software that causes information to be formatted and presented to a user of the system, for example on a monitor. In the embodiment shown in FIG. 1, layer 12 includes a web interface 14, a human machine interface (HMI) 16 for the power control management system, standard screens and wizards 18 to be used with HMI 16, and a remote monitoring package 20.

An application layer 30 includes software packages that further filter, refine and analyze data sent and retrieved from hardware comprising power control management system 10. As an example, if a device in system 10 measures and analyzes a voltage waveform, a software package in application layer 30 compares a measured value of samples of the waveform against known upper and lower limit values as part of a test. Included in application layer 30 are windows applications 32, an oscillography analysis and retriever module 36, a sequence of events analysis and retriever module 40, a data analyzer module 42, and a reporting tool 44. Oscillography analysis and retriever module 36 typically facilitates functions such as voltage waveform measurement and comparisons to known quantities.

Sequence of events analysis and retriever module 40 typically facilitates functions such as measurement and reporting of timing events, for example, frequency, or when a switch is turned off or on.

A dynamic data exchange (DDE)/object linking and embedding (OLE) for Process Control and operating system layer 50 includes control computer hardware 52 and associated servers. In a Power Management Host PC, such as system 10, there are a number of commercially available proprietary protocol specific servers, for example Ethernet Server 54, Modbus® Server 56, MMS Server 58 and ION® Subsystem 60. Modbus is a registered trademark of Gould Inc, located at 10 Gould Center, Rolling Meadows Ill. 60008, and ION is a registered trademark of Power Management LTD., located at 6703 Rajpur Place Victoria, British Columbia Canada. Dynamic data exchange and/or OLE for process control (OPC) allows external programs to access data in a windows environment through communications layer 70. Modbus server 56 facilitates direct communication with a Modbus concentrator 72, for communication with Modbus devices or other serial-communications based devices when a computer 52 is directly connected to a serial network. Further, Ethernet server 54 provides for Ethernet communication with a proprietary Ethernet gateway 74 typically located at or near IEDs to be controlled within system 10. Control computer 52 and gateway 74 are electrically connected using an Ethernet medium (not shown). Server 54 and gateway 74 are, in known systems, proprietary products, custom designed for communication with a known set of intelligent end devices (IEDs). Typically, Ethernet server 54 and gateway 74 are supplied as one product of a manufacturer, and communications between the devices are accomplished using non-industry standard communications protocols. Therefore, to incorporate IEDs from multiple vendors into a system, such as system 10, multiple proprietary Ethernet servers must be incorporated into the system.

The servers listed above service a plurality of communication interfaces as shown in communication interface layer 70. Included in layer 70 are several gateways including a Modbus concentrator 72, proprietary Ethernet gateway 74, a Modbus monitor 76, a utility communication architecture (UCA/MMS) and universal relay devices 78, and a dial up modem 82.

A meter and protection devices layer 100 shows a variety of devices available for communication within power control management system 10. A variety of communications protocols are also shown. Using the Modbus concentrator 72, multiple devices 102 communicate on a Modbus Network. Meters 104 and relay devices 106 communicate using proprietary Ethernet gateway 74. Programmable logic controllers 108 and other legacy/third party applications 110 communicate directly with computer 52 either through a serial port attached to the computer or via the Ethernet.

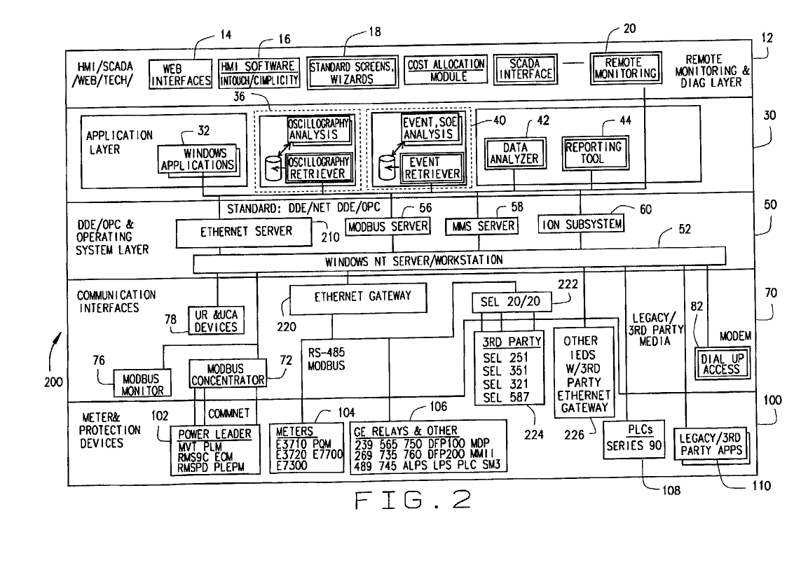

FIG. 2 is a power control management system 200 according to one embodiment of the present invention. System 200 includes many of the same devices, packages and interfaces shown in system 10 of FIG. 1. Components in system 200 identical to components of system 10 are identified in FIG. 2 using the same reference numerals used in FIG. 1. System 200 includes an Ethernet server 210, which provides communications within a network (not shown). Ethernet server 210 is configured for support of IEDs supplied by multiple third party vendors as described below. System 200 further includes an Ethernet gateway 220, meters 104, relays 106, a third party protocol converter 222 that communicates with third party IEDs 224, and other IEDs 226. Ethernet gateway 220 controls and programs multiple devices, such as meters 104, relays 106, third party protocol converter 222, and third party IEDs 224. Other IEDs 226 include an Ethernet gateway and are directly controlled and programmed by Ethernet server 210. IEDs 224 and 226 perform the hardware control functions of the power control management system, and in one embodiment includes on-board Ethernet gateways which also communicate with the power control management system Ethernet server. Third party IEDs 224 and other IEDs 226 are typically supplied by multiple third party vendors and have proprietary communications schemes.

Third party protocol converter 222, third party IEDs 224 and other IEDs 226 that are directly supported through a third-party Ethernet gateway for addition into known power control management systems have heretofore been unavailable. Typically, Ethernet servers 54 (shown in FIG. 1) have been configured such that server 54 could only communicate through proprietary gateways, for example gateway 74 (shown in FIG. 1). Any attempt to communicate with a gateway such as Ethernet gateway 220 required a software driver and corresponding gateway which communicated in the same manner from the same vendor. Without additional software or protocol conversions means, server 210 supports communication with any serial based 3rd party gateway, and therefore IEDs, that directly embed the serial protocol in the data portion of the TCP/IP Ethernet packet. Thus, server 210 enables communications between serial-based IEDs and a power management control system (PMCS), for example system 200, such that the IEDs can be connected to the PMCS without the need for proprietary software drivers and gateways.

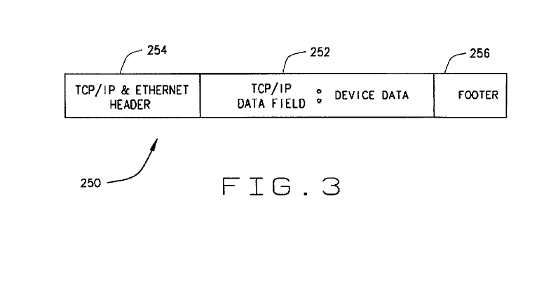

FIG. 3 is a block diagram of a typical TCP/IP Ethernet communication protocol, including packeted device data 252, a header 254, and a footer 256. Ethernet server 210 and gateway 220 (shown in FIG. 2) use TCP/IP communications protocol 250 when communicating with a computer network including network devices such as printers, scanners, programmable logic controllers, and other computers (not shown). Additionally, Ethernet server 210 and gateway 220 (both shown in FIG. 2) allow the computer network to communicate with other devices, such as meters 104, relays 106 and third party IED's 226 (shown in FIG. 2), using other communication protocols. Server 210 encapsulates data 252 for a device, for example, a Modbus remote terminal unit, by packeting data 252 intended for the device within header 254 and, if necessary, a footer 256. Thereafter, gateway 220 removes header 254 and footer 256 before sending data 252 to the devices.

Ethernet Server 210 is, in one embodiment, a software program running in layer 50 which creates and encapsulates Modbus messages intended for system IED's residing in layer 100. Server 210 encapsulates Modbus messages 252 in an industry standard format with an industry standard TCP/IP Ethernet message header 254 and footer 256. Server 210 encapsulates the Modbus messages 252, with header 254 and footer 256 in order to transport Modbus message 252, in the industry standard format, across an Ethernet network to Ethernet Gateway 220. Ethernet Gateway 220, upon receiving the message extracts Modbus message 252, by extracting header 254 and footer 256, from the data portion of the Ethernet message and transmits Modbus message 252 to the device. When an IED at layer 100 returns messages to the Ethernet Server 210, Gateway 220 encapsulates the returned message with a header 254 and footer 256, before passing the returned message to Ethernet server 210.

Ethernet Server 210 further acts as a communication server to one or more software programs residing within layer 30. Note that layer 50 also includes other communications servers (one for each type of support system protocol: Modbus, MMS, ION). As a communication server, Ethernet Server 210 acts as a conduit for all communication between the software programs within layer 30 and Ethernet Gateway 220 and eventually to the IEDs, for example, IEDs 226. Ethernet Server 210 is electrically connected to Ethernet Gateway 220 via an Ethernet network. Ethernet Gateway 220 is further electrically connected to one or more IEDs 226 via an Ethernet network.

Ethernet server 210 and Ethernet gateway 220 allow industry standard programming protocols to be used when communicating with multiple IEDs 226, supplied by multiple vendors, thereby allowing a user to take advantage of industry standardization in computer networking and connect the IED directly to the gateway without having concern whether the gateway and the PC-based server software have been specially designed and programmed to support the new device. Industry standardization provides additional benefits when a system user is adding additional IEDs to a system, which need to communicate with the system.

While the invention has been described in terms of various specific embodiments, those skilled in the art will recognize that the invention can be practiced with modification within the spirit and scope of the claims.

1. A power control management system comprising:
at least one intelligent end device (IED);
a control computer comprising an Ethernet server configured to create and encapsulate messages intended for said IEDs, in an industry standard format;
and
an Ethernet gateway configured to communicate with said server and transmit messages to said IEDs.

2. A power control system according to claim 1 wherein said server further configured to encapsulate messages with a TCP/IP Ethernet header and footer.

3. A power control system according to claim 2 wherein said gateway further configured to extract the TCP/IP Ethernet header and footer from the encapsulated messages.

4. A power control system according to claim 3 wherein said gateway further configured to transmit messages to at least one IED.

5. A power control system according to claim 1 wherein said gateway further configured to encapsulate messages returned from said IEDs with an industry standard header and footer for transmission to said Ethernet server.

6. A power control management system according to claim 5 wherein the messages are encapsulated with a TCP/IP Ethernet header and footer.

7. A power control management system according to claim 1 wherein said server is further configured to act as a communications server for other programs resident in an applications layer.

8. A power control system according to claim 1 further comprising at least one IED configured with said Ethernet gateway.

9. A method for communicating with intelligent end devices (IEDs) in a power control management system including at least one IED, an Ethernet gateway, and a control computer including an Ethernet server, said method comprising the steps of:
electrically connecting the Ethernet gateway to the Ethernet server;
configuring the server to create and encapsulate messages intended for IEDs in an industry standard format;
configuring the gateway to remove the encapsulation from received messages for transmission to the IEDs; and
transmitting the messages to the IEDs.

10. A method according to claim 9 wherein said step of configuring the server to create and encapsulate messages comprises the step of encapsulating messages with a TCP/IP Ethernet header and footer.

11. A method according to claim 10 wherein said step of configuring the gateway to remove the encapsulation from received messages comprises the step of configuring the gateway to extract the TCP/IP Ethernet header and footer from the encapsulated messages.

12. A method according to claim 11 further comprising the steps of:
configuring the gateway to encapsulate messages returned from the IEDs with an industry standard header and footer; and
transmitting the encapsulated messages to the Ethernet server.

13. A method according to claim 12 wherein said step of configuring the gateway comprises the step of encapsulating the messages with a TCP/IP Ethernet header and footer.

14. A method according to claim 9 further comprising the step of configuring the Ethernet server to act as a communications server for other programs resident in an applications layer.

15. A computer programmed to create and encapsulate messages in an industry standard format, said computer further programmed to function as an Ethernet server for transmission of the messages.

16. A computer according to claim 15 further programmed to encapsulate messages with a TCP/IP Ethernet header and footer.

17. An Ethernet gateway comprising a programmable hardware device configured to:
receive Ethernet messages from an Ethernet server in an industry standard format;
remove both an Ethernet header and footer from the received Ethernet messages, leaving a message for transmission to at least one intelligent end device (IED); and
transmit the messages to the at least one IED.

18. An Ethernet gateway according to claim 17 wherein the Ethernet header and footer are in a TCP/IP format.

19. An Ethernet gateway according to claim 17 wherein said programmable hardware device is further programmed to receive messages from intelligent end devices.

20. An Ethernet gateway according to claim 19 wherein said programmable hardware device is further programmed to:
encapsulate received messages with an Ethernet header and footer; and
transmit the encapsulated messages to an Ethernet server.

21. An Ethernet gateway according to claim 20 wherein the messages are encapsulated with a TCP/IP header and footer.
